(19) United States
(12) Patent Application Publication
(10) Pub. No.: US 2026/0050337 A1
(43) Pub. Date: Feb. 19, 2026

(54) DISPLAY PANEL AND DRIVING METHOD

(71) Applicant: WUHAN CHINA STAR OPTOELECTRONICS SEMICONDUCTOR DISPLAY TECHNOLOGY CO., LTD., Wuhan, Hubei (CN)

(72) Inventors: Shuiqin SHUAI, Wuhan, Hubei (CN); Zengjian JIN, Wuhan, Hubei (CN)

(73) Assignee: WUHAN CHINA STAR OPTOELECTRONICS SEMICONDUCTOR DISPLAY TECHNOLOGY CO., LTD., Wuhan, Hubei (CN)

(21) Appl. No.: 18/262,741

(22) PCT Filed: May 31, 2023
(86) PCT No.: PCT/CN2023/097442

§ 371 Date: Jul. 25, 2023

(30) Foreign Application Priority Data
May 11, 2023 (CN) 202310539794.8

(51) Int. Cl. G06F 3/041; G06F 3/044; G06F 3/046

(52) U.S. Cl. CPC G06F 3/0412; G06F 3/04164; G06F 3/04166; G06F 3/0445; G06F 3/0446; G06F 3/046; G06F 2203/04106; G06F 2203/04111

(57) ABSTRACT

The present application provides a display panel and a driving method. The display panel includes a capacitive touch part. The capacitive touch part includes a first capacitive touch portion and a second capacitive touch portion arranged in different layers. The display panel includes electromagnetic coils. The electromagnetic coils include an electromagnetic touch part. The electromagnetic touch part includes a first electromagnetic touch portion and a second electromagnetic touch portion arranged in different layers. At least one of the first electromagnetic touch portion and the second electromagnetic touch portion is arranged in a same layer as the capacitive touch part.

### FIELD OF DISCLOSURE

The present application relates to a field of display technology, in particular to a display panel and a driving method.

### DESCRIPTION OF RELATED ART

Compared with liquid crystal display panels, organic light-emitting diode (OLED) display panels have the advantages of being thinner, better display quality, high resolution, wide color gamut, lower power consumption, achieving flexible displays, etc. Therefore, Therefore, OLED display panels have experienced rapid development in recent years and have become the preferred display panel type for small to medium-sized devices.

At present, the general way to make the display panel to have electromagnetic touch functions is to dispose an additional extra electromagnetic coil layer in the display panel or outside the display panel. However, this approach leads to overall increased thickness of the display panel larger and complicates manufacturing processes, posing technical shortcomings.

In view of the above-mentioned technical shortcomings, there is an urgent need to design a display panel that is thin and light and has a relatively simplified manufacturing process.

### SUMMARY OF INVENTION

The present application provides a display panel and a driving method, which can effectively solve the problems of increased overall thickness and complicated manufacturing process associated with conventional display panels equipped with electromagnetic touch functions.

In one aspect, the present application provides a display panel. The display panel includes a capacitive touch part, and the capacitive touch part includes a first capacitive touch portion and a second capacitive touch portion arranged in different layers. The display panel includes a plurality of electromagnetic coils include an electromagnetic touch part that includes a first electromagnetic touch portion and a second electromagnetic touch portion arranged in different layers, wherein at least one of the first electromagnetic touch portion and the second electromagnetic touch portion is arranged in a same layer as the capacitive touch part.

Optionally, the plurality of electromagnetic coils further include the capacitive touch part.

Optionally, the first capacitive touch portion includes a plurality of touch electrodes, the second capacitive touch portion includes a plurality of bridging electrodes, the first electromagnetic touch portion includes a plurality of electromagnetic coil lines, and the second electromagnetic touch portion includes a plurality of electromagnetic bridging lines. An area of the plurality of touch electrodes is larger than an area of the plurality of bridging electrodes, an area of the plurality of electromagnetic coil lines is larger than an area of the plurality of electromagnetic bridging lines, and the electromagnetic coil lines are arranged in a same layer as the bridging electrodes.

Optionally, the electromagnetic bridging lines are arranged in a same layer as the touch electrodes.

Optionally, each of the electromagnetic bridging lines, each of the touch electrodes, and each of the bridging electrodes are arranged in different layers.

Optionally, the second electromagnetic touch portion further includes a plurality of parallelly connected electromagnetic coil structures, and the parallelly connected electromagnetic coil structures are connected in parallel with the electromagnetic coil lines.

Optionally, the touch electrodes comprises a plurality of first touch electrodes and a plurality of second touch electrodes, each of the first touch electrode includes a plurality of first touch sub-electrodes arranged sequentially in a first direction, each two adjacent first touch sub-electrodes are electrically connected to each other, the second touch electrodes comprise a plurality of second touch sub-electrodes arranged sequentially in a second direction, and each two adjacent second touch sub-electrodes are electrically connected by the corresponding bridging electrode; the electromagnetic coils include a plurality of first electromagnetic coils and a plurality of second electromagnetic coils; each of the first electromagnetic coils includes two first main segments extending along the first direction, wherein one of the two first main segments includes the corresponding electromagnetic coil line, and the other one of the two first main segments includes the corresponding first touch electrode; each of the second electromagnetic coils includes two second main segments extending along the second direction, wherein one of the two second main segments includes the corresponding electromagnetic coil line, and the other one of the two second main segments includes the corresponding second touch electrode; and the first direction is perpendicular to the second direction.

Optionally, an orthographic projection of the electromagnetic bridging line in a third direction is non-overlapped with an orthographic projection of the bridging electrode in the third direction, and the third direction is perpendicular to the first direction and the second direction.

Optionally, an area surrounded by each of the first electromagnetic coils partially overlaps with an area surrounded by at least one of the first electromagnetic coils, and an area surrounded by each of the second electromagnetic coils partially overlaps with an area surrounded by at least one of the second electromagnetic coils.

Optionally, each of the first electromagnetic coils further includes a first connecting segment connected to the two first main segments, and each of the second electromagnetic coils further includes a second connecting segment connected to the two second main segments, wherein the display panel includes a plurality of data lines parallel to the first main segments or the second main segments, when the first main segments are parallel to the data lines, at least one of the second connecting segments is disposed on each of two sides of the respective data lines; and when the second main segments are parallel to the data lines, at least one of the first connecting segments is disposed on each of two sides of the respective data lines.

Optionally, the plurality of electromagnetic coils exclude the capacitive touch part.

In another aspect, the present application provides a driving method of a display panel, wherein the display panel includes a capacitive touch part, and the capacitive touch part includes a first capacitive touch portion and a second capacitive touch portion arranged in different layers. The display panel includes a plurality of electromagnetic coils, the plurality of electromagnetic coils include an electromagnetic touch part, and the electromagnetic touch part includes a first electromagnetic touch portion and a second electromagnetic touch portion arranged in different layers, wherein at least one of the first electromagnetic touch portion and the second electromagnetic touch portion is disposed in a same layer as the capacitive touch part, and the plurality of electromagnetic coils further include the capacitive touch part. The driving method of the display panel includes: scanning a capacitive touch part in the display panel using a touch driving chip, each scan cycle including an electromagnetic scan interval and a capacitive scan interval, wherein during each electromagnetic scan interval, the capacitive touch portion performs an electromagnetic touch function, and during each capacitive scan interval, the capacitive touch portion performs a capacitive touch function.

### BENEFICIAL EFFECTS

The present application provides a display panel and a driving method. The display panel includes a capacitive touch part. The capacitive touch part includes a first capacitive touch portion and a second capacitive touch portion arranged in different layers. The display panel includes a plurality of electromagnetic coils, and the plurality of electromagnetic coils include an electromagnetic touch part. The electromagnetic touch part includes a first electromagnetic touch portion and a second electromagnetic touch portion arranged in different layers, wherein at least one of the first electromagnetic touch portion and the second electromagnetic touch portion is arranged in a same layer as the capacitive touch part. In the present application, by arranging at least one of the first electromagnetic touch portion and the second electromagnetic touch portion in the same layer as the capacitive touch part, a partial structure of the electromagnetic touch part can be formed in a space of a film layer where the capacitive touch part is located, thereby improving a problem of overall greater thickness and the complexity of a manufacturing process of the display panel equipped with electromagnetic touch functionality.

### BRIEF DESCRIPTION OF DRAWINGS

In order to more clearly illustrate the technical solutions in the embodiments of the present application, the drawings used in the description of the embodiments will be briefly described below. It is obvious that the drawings in the following description are only some embodiments of the present application. Other drawings may also be obtained by those of ordinary skill in the art based on these drawings without inventive work.

FIG. 1 is a schematic structural view of a display panel according to a first embodiment of the present application.

FIG. 2 is a schematic structural view of a touch layer according to the first embodiment of the present application.

FIG. 3 is a schematic plan view of a capacitive touch part according to the first embodiment of the present application.

FIG. 4 is a schematic plan view of a first touch electrode according to the first embodiment of the present application.

FIG. 5 is a schematic plan view of a second touch electrode according to the first embodiment of the present application.

FIG. 6 is a schematic plan view of a bridging electrode according to the first embodiment of the present application.

FIG. 7 is a schematic plan view of an electromagnetic touch part according to the first embodiment of the present application.

FIG. 8 is a schematic plan view of a first electromagnetic coil according to the first embodiment of the present application.

FIG. 9 is a schematic plan view of a second electromagnetic coil according to the first embodiment of the present application.

FIG. 10 is a schematic structural view of the touch layer according to a second embodiment of the present application.

FIG. 11 is a schematic structural view of the touch layer according to a third embodiment of the present application.

FIG. 12 is a schematic structural view illustrating the touch layer being a first type structure according to a fourth embodiment of the present application.

FIG. 13 is a schematic structural view illustrating the touch layer being a second type structure according to the fourth embodiment of the present application.

### REFERENCE SIGNS

display panel 01; substrate 10; driving circuit layer 20; display functional layer 30; encapsulation layer 40; touch layer 50; first insulating layer 51; first touch layer 52; second touch layer 54; third insulating layer 55; third touch layer 56; electromagnetic coil M0; first electromagnetic coil M1; first main segment M11; first connecting segment M12; second electromagnetic coil M2; second main segment M21; second connecting segment M22; capacitive touch part C0; first capacitive touch portion C1; touch electrode C11; first touch electrode C111; first touch sub-electrode C1111; second touch electrode C112; second touch sub-electrode C1121; second capacitive touch portion C2; bridging electrode C21; electromagnetic touch part E0; first electromagnetic touch portion E1; electromagnetic coil line E11; second electromagnetic touch portion E2; electromagnetic bridging line E21 ; parallelly connected electromagnetic coil structure E22 ; first direction X; second direction Y; third direction Z;

### DETAILED DESCRIPTION OF EMBODIMENTS

The present application is described below with reference to the accompanying drawings to clearly and completely describe the technical solutions in the embodiments of the present application. Obviously, the described embodiments are only some embodiments of the present application, rather than all the embodiments. Based on the embodiments in this present application, all other embodiments obtained by those skilled in the art without creative work shall fall within the protection scope of this present application. In addition, it should be understood that the specific embodiments described here are only used to illustrate and explain the present application, and are not used to limit the present application. In this application, unless otherwise stated, the directional words such as “up” and “down” generally refer to orientations of the device in actual use or working state, specifically as depicted in the drawings. The terms “inner” and “outer” are used in reference to the device's outline or contour.

Following disclosure provides many different embodiments or examples for implementing different structures of the present application. In order to simplify the disclosure of the present application, components and configurations of specific examples are described below. Certainly, the examples are only for illustrative purposes, and are not intended to limit the present application. Furthermore, in this application, repeated reference numerals and/or reference letters may be used in different examples for the purpose of simplicity and clarity. Such repetition does not, by itself, indicate a relationship between the various embodiments and/or configurations being discussed. In addition, the present application provides examples of various specific processes and materials, but one of ordinary skill in the art can recognize the application of other processes and/or the use of different materials. Detailed descriptions are given below for illustrative purposes. It should be noted that the order of description in the following embodiments does not imply any preferred sequence of the embodiments.

The present application provides a display panel and a driving method. The display panel includes a capacitive touch part. The capacitive touch part includes a first capacitive touch portion and a second capacitive touch portion arranged in different layers. The display panel includes a plurality of electromagnetic coils, and the plurality of electromagnetic coils include an electromagnetic touch part. The electromagnetic touch part includes a first electromagnetic touch portion and a second electromagnetic touch portion arranged in different layers, wherein at least one of the first electromagnetic touch portion and the second electromagnetic touch portion is disposed in a same layer as the capacitive touch part.

In the display panel of the present application, the electromagnetic touch part is configured to realize an electromagnetic touch function. Users can activate the electromagnetic touch function through an electromagnetic pen. The capacitive touch part is configured to realize a capacitive touch function, and users can activate the capacitive touch function with their fingers.

In conventional related arts, the first capacitive touch portion and the second capacitive touch portion arranged in different layers as well as the first electromagnetic touch portion and the second electromagnetic touch portion arranged in different layers are respectively located in four different film layers in the display panel, resulting a significant increase in an overall thickness of the display panel.

In the present application, by arranging at least one of the first electromagnetic touch portion or the second electromagnetic touch portion in a same layer as the capacitive touch part, a space of a film layer where the capacitive touch part is located can be used to form a partial structure of the electromagnetic touch part, thereby improving the problems of a greater overall thickness and a more complicated manufacturing process associated with the display panel equipped with the electromagnetic touch function. At least one of the first electromagnetic touch portion and the second electromagnetic touch portion being arranged in the same layer as the capacitive touch part includes: the first electromagnetic touch portion is arranged in a same layer as the first capacitive touch portion, and the second electromagnetic touch portion is arranged in a same layer as the second capacitive touch portion; the first electromagnetic touch portion is arranged in a same layer as the second capacitive touch portion, and the second electromagnetic touch portion is arranged in a same layer as the first capacitive touch portion; the first electromagnetic touch portion and the first capacitive touch portion are arranged in a same layer, and the second electromagnetic touch portion, the first capacitive touch portion, and the second capacitive touch portion are arranged in different layers; the first electromagnetic touch portion and the second capacitive touch portion are arranged in a same layer, and the second electromagnetic touch portion, the first capacitive touch portion, and the second capacitive touch portion are arranged in different layers; the second electromagnetic touch portion and the first capacitive touch portion are arranged in a same layer, and the first electromagnetic touch portion, the first capacitive touch portion, and the second capacitive touch portion are arranged in different layers; and the second electromagnetic touch portion and the second capacitive touch portion are arranged in a same layer, and the first electromagnetic touch portion, the first capacitive touch portion, and the second capacitive touch portion are arranged in different layers.

### First Embodiment

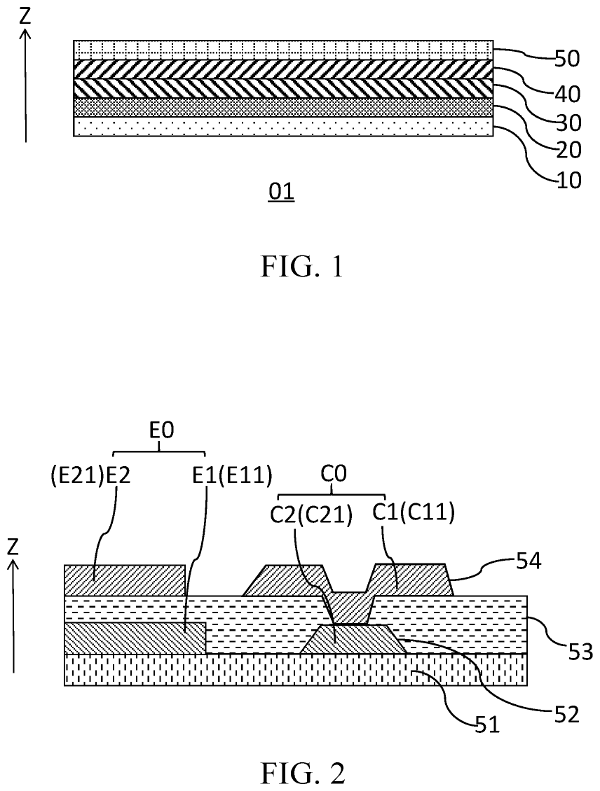

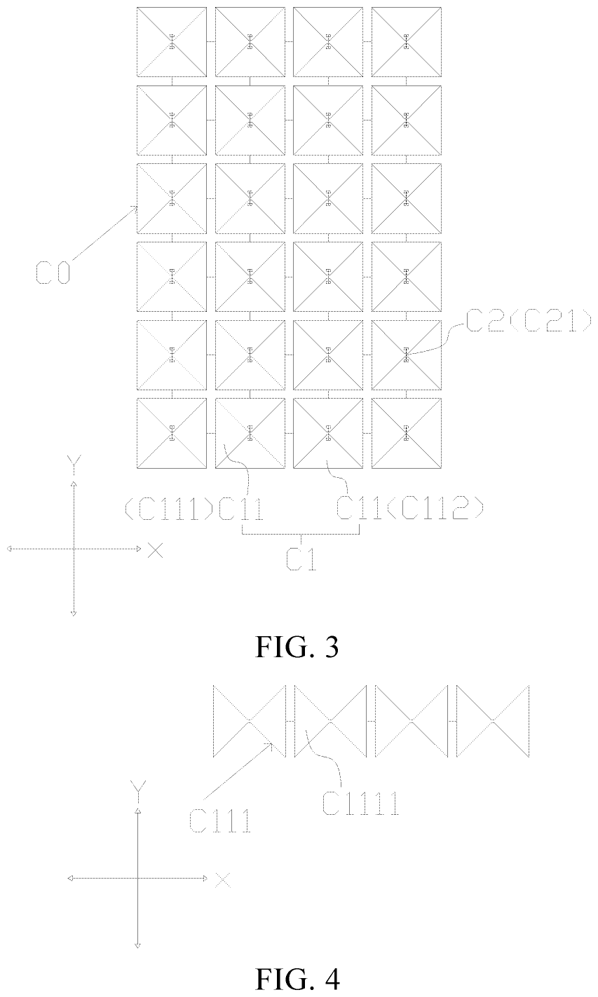

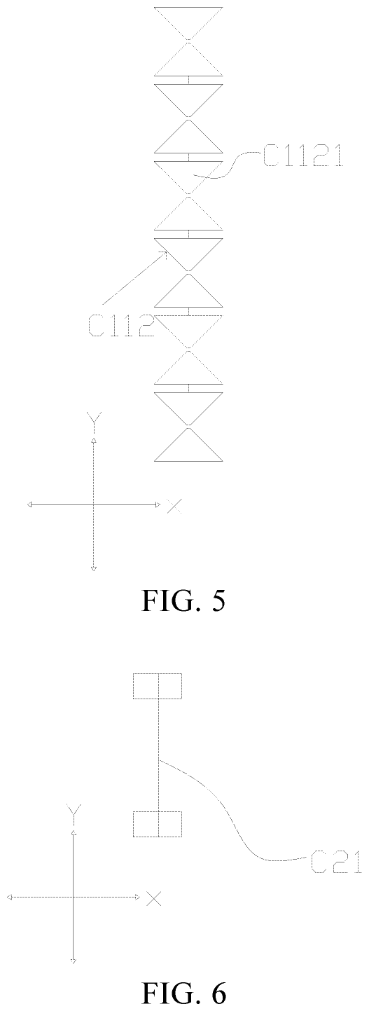

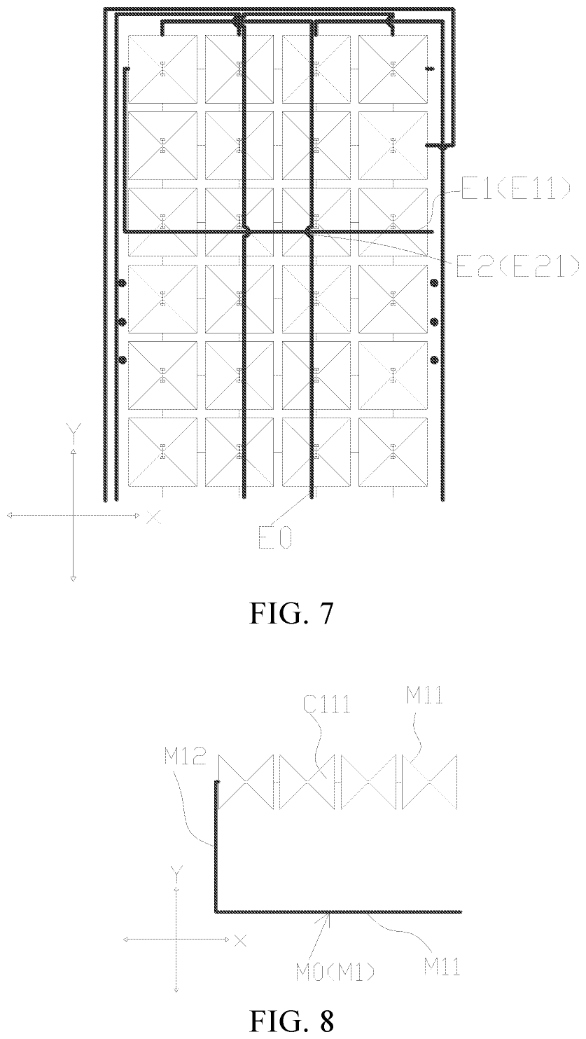

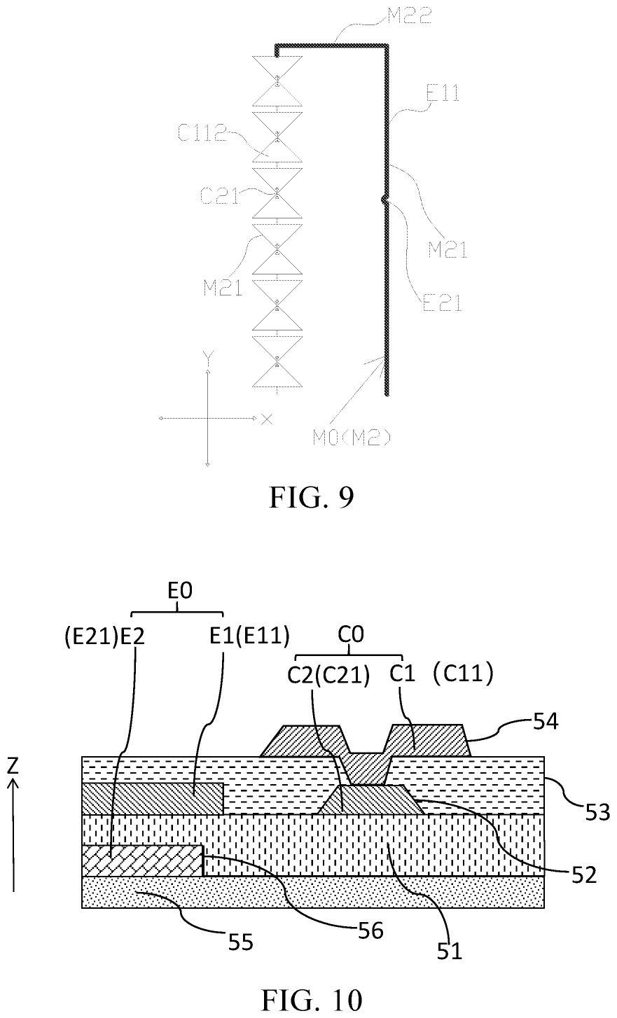

In a first aspect, the first embodiment of the present application provides a display panel. FIG. 1 is a schematic structural view of a display panel according to the first embodiment of the present application. FIG. 2 is a schematic structural view of a touch layer according to the first embodiment of the present application. FIG. 3 is a schematic plan view of a capacitive touch part according to the first embodiment of the present application. FIG. 4 is a schematic plan view of a first touch electrode according to the first embodiment of the present application. FIG. 5 is a schematic plan view of a second touch electrode according to the first embodiment of the present application. FIG. 6 is a schematic view of a bridging electrode according to the first embodiment of the present application. FIG. 7 is a schematic plan view of an electromagnetic touch part according to the first embodiment of the present application. FIG. 8 is a schematic plan view of a first electromagnetic coil according to the first embodiment of the present application. FIG. 9 is a schematic plan view of a second electromagnetic coil according to the first embodiment of the present application. As shown in FIG. 1 to FIG. 9, the first embodiment of the present application provides a display panel 01 and a capacitive touch part C0 of the display panel 01. The capacitive touch part C0 includes a first capacitive touch portion C1 and a second capacitive touch portion C2 arranged in different layers. The display panel 01 includes a plurality of electromagnetic coils MO. The plurality of electromagnetic coils M0 includes an electromagnetic touch part E0. The electromagnetic touch part E0 includes a first electromagnetic touch portion E1 and a second electromagnetic touch portion E2 arranged in different layers, wherein the second electromagnetic touch portion E2 and the first capacitive touch portion C1 are arranged in a same layer.

In the display panel 01 of the present application, the second electromagnetic touch portion E2 is arranged in the same layer as the first capacitive touch portion C1. As a result, the present application avoids the problem of an increased number of film layers and an increased thickness of the display panel 01 caused by the addition of the second electromagnetic touch portion E2, enabling the display panel 01 to have a thinner thickness. Furthermore, the present application simplifies the manufacturing process of the display panel 01 and reduces production costs.

In some embodiments of the present application, the plurality of electromagnetic coils MO include the electromagnetic touch part E0 and the capacitive touch part C0.

In conventional techniques, the electromagnetic coil M0 only includes the electromagnetic touch part E0, that is, the electromagnetic touch part E0 and the capacitive touch part C0 are distinct components independent from each other.

In the display panel 01 of the present application, the plurality of electromagnetic coils M0 include the electromagnetic touch part E0 and the capacitive touch part C0. As a result, the capacitive touch part C0 can be used to form a part of the electromagnetic coils M0, thereby reducing a layout area of the electromagnetic touch part E0, decreasing the complexity of the manufacturing process, and improving the space utilization of the display panel 01.

In some embodiments of the present application, the first capacitive touch portion C1 includes a plurality of touch electrodes C11, and the second capacitive touch portion C2 includes a plurality of bridging electrodes C21. The first electromagnetic touch portion E1 includes a plurality of electromagnetic coil lines E11, and the second electromagnetic touch portion E2 includes a plurality of electromagnetic bridging lines E21. An area of the plurality of touch electrodes C11 is larger than an area of the plurality of bridging electrodes C21, an area of the plurality of electromagnetic coil lines E11 is larger than an area of the plurality of electromagnetic bridging lines E21, and the electromagnetic coil lines E11 and the bridging electrodes C21 are arranged in a same layer.

In the display panel 01 of the present application, the touch electrodes C11 belong to the first capacitive touch portion C1, and the bridging electrodes C21 belong to the second capacitive touch portion C2. Therefore, the touch electrodes C11 and the bridging electrodes C21 are arranged in different layers. Since the area of the plurality of touch electrodes C11 is larger than the area of the plurality of bridging electrodes C21, the film layer where the bridging electrodes C21 are located has a larger unoccupied area. In the present application, the electromagnetic coil lines E11 with a larger area are arranged in the film layer where the bridging electrodes C21 are located with a larger unoccupied area, so that the present application enables the simplification of the film layer structure of the display panel 01 and reduces its thickness, while also making more efficient use of the space within the film layers where the first capacitive touch portion C1 and the second capacitive touch portion C2 are located. This, in turn, lowers the wiring difficulty of the electromagnetic touch part E0, improves product yield, and reduces production costs.

Specifically, the display panel 01 includes a substrate 10 and includes a driving circuit layer 20, a display functional layer 30, an encapsulation layer 40, and a touch layer 50 stacked in sequence on the substrate 10. The touch layer 50 includes a first insulating layer 51, a first touch layer 52, a second insulating layer 53, and a second touch layer 54 stacked in sequence in a direction away from the encapsulation layer 40. The touch electrodes C11 in the first capacitive touch portion C1 are arranged in the second touch layer 54, and the electromagnetic bridging lines E21 in the second electromagnetic touch portion E2 are arranged in the second touch layer 54. That is to say, the electromagnetic bridging lines E21 are arranged in a same layer as the touch electrodes C11.

In the display panel 01 of the present application, the electromagnetic coil lines E11 are arranged in the same layer as the bridging electrodes C21, the electromagnetic bridging lines E21 are arranged in the same layer as the touch electrodes C11. Therefore, the electromagnetic coil lines E11 in the first electromagnetic touch portion E1 and the bridging electrodes C21 in the second capacitive touch portion C2 can share a same film layer, so that the electromagnetic bridging lines E21 in the second electromagnetic touch portion E2 and the touch electrodes C11 in the first capacitive touch portion C1 can share a same film layer. Accordingly, the electromagnetic touch part E0 can share the space of the touch layer 50 with the capacitive touch part C0, thereby preventing an increase in the number of film layers of the display panel 01 due to the inclusion of the electromagnetic touch part E0, thus providing advantages of a slim profile and a simplified manufacturing process for the display panel 01.

Certainly, the present application does not impose any restrictions on the vertical positioning relationship between the first touch layer 52 and the second touch layer 54. For example, in other embodiments of the present application, the first touch layer 52 can be positioned on a side of the second touch layer 54 away from the encapsulation layer 40.

In some embodiments of the present application, the touch electrodes C11 includes a plurality of first touch electrodes C111 and a plurality of second touch electrodes C112. Each of the first touch electrodes C111 includes a plurality of first touch sub-electrodes C1111 sequentially arranged in a first direction X, and each two adjacent first touch sub-electrodes C1111 are electrically connected. The second touch electrodes C112 includes a plurality of second touch sub-electrodes C1121 sequentially arranged in a second direction Y, and each two adjacent second touch sub-electrodes C1121 are electrically connected through the bridging electrode C21. The electromagnetic coils M0 include a plurality of first electromagnetic coils M1 and a plurality of second electromagnetic coils M2. Each first electromagnetic coil M1 includes two first main segments M11 extending along the first direction X, wherein one of the two first main segments M11 includes an electromagnetic coil line E11, and the other first main segment M11 includes the first touch electrode C111. Each of the second electromagnetic coils M2 includes two second main segments M21 extending along the second direction Y, wherein one of the two second main segments M21 includes the electromagnetic coil line E11, and the other second main segment M21 includes the second touch electrode C112. The first direction X is perpendicular to the second direction Y.

In the display panel 01 of the present application, one of the first main segments M11 of the first electromagnetic coil M1 includes the first touch electrode C111, and one of the second main segments of the second electromagnetic coil M2 includes the second touch electrode C112. That is to say, the first touch electrode C111 and the second touch electrode C112 can be used not only as a capacitive touch channel, but also as an electromagnetic touch channel. This realizes both electromagnetic touch driving and capacitive touch driving by using one single touch driving chip, thereby improving the integration of the display panel 01 and simplifying the structure of the display panel 01. Additionally, since each touch channel is arranged to correspond to a pin on one touch driving chip, the present application also reduces the number of pins and narrow a bezel of the display panel 01.

It should be noted that the present application does not limit the orientations of the first direction X and the second direction Y. In other embodiments of the present application, the orientations of the first direction X and the second direction Y can be interchanged.

In some embodiments of the present application, an orthographic projection of the electromagnetic bridging line E21 in a third direction Z does not overlap with an orthographic projection of the bridging electrode C21 in the third direction Z. The third direction Z is perpendicular to the first direction X and the second direction Y.

In the display panel 01 of the present application, the electromagnetic bridging line E21 is arranged in the second touch layer 54. The electromagnetic bridging line E21 is electrically connected to the electromagnetic coil line E11 in the first touch layer 52 through a via hole. Since the bridging electrode C21 is also arranged in the first touch layer 52, the present application effectively prevents short circuits between the bridging electrode C21 and the electromagnetic bridging line E21 and thereby improves the touch performance of display panel 01 by means of a layout in which the orthographic projection of the electromagnetic bridging line E21 in the third direction Z does not overlap with the orthographic projection of the bridging electrode C21 in the third direction Z.

Furthermore, the electromagnetic bridging line E21 and the touch electrode C11 are arranged in a staggered manner in the second touch layer 54, and the electromagnetic coil line E11 and the bridging electrode C21 are also arranged in a staggered manner in the first touch layer 52.

In some embodiments of the present application, an area surrounded by each of the first electromagnetic coils M1 partially overlaps with an area enclosed by at least one of the first electromagnetic coils M1. An area enclosed by each of the second electromagnetic coils M2 partially overlaps with an area surrounded by at least one of the second electromagnetic coils M2.

In the display panel 01 of the present application, the area surrounded by each of the first electromagnetic coils M1 partially overlaps with the area surrounded by at least one of the first electromagnetic coils M1, and the area surrounded by each of the second electromagnetic coils M2 partially overlaps with the area surrounded by at least one of the second electromagnetic coils M2. This can increase the electromagnetic signal quantity in areas surrounded by the electromagnetic coils M0, which is beneficial for improving the electromagnetic induction sensitivity and accuracy of the display panel 01.

In some embodiments of the present application, each of the first electromagnetic coils M1 further includes a first connecting segment M12 connected to two first main segments M11, and each of the second electromagnetic coils M2 further includes a second connecting segment M22 connected to two second main segments M21. The display panel 01 includes a plurality of data lines, and the first main segment M11 or the second main segment M21 is parallel to the data lines. When the second main segment M11 is parallel to the data lines, at least one second connecting segment M22 is disposed on each of two sides of the data line. When the second main segment M21 is parallel to the data line, at least one first connecting segment M12 is disposed on each of two sides of the data line.

Specifically, the display panel 01 of the present application further includes, for example, a touch driving chip disposed at one end of the data line. The touch driving chip is disposed at the end of the data line, an end of each electromagnetic coil MO needs to be electrically connected to the touch driving chip, the electromagnetic coil MO where the second connecting segment M22 or the first connecting segment M12 is located on one side of the data line needs to wind to be finally connected to the touch driving chip. Therefore, when the second connecting segments M22 or the first connecting segments M12 are arranged on a same side of the data line, it results in a densely wiring situation on that side, increasing the difficulty of wiring. This way, the present application balances the number of wire windings on both sides of the data line and reduce the wiring difficulty by having at least one second connecting segment M22 on each of two sides of the data line or at having at least one first connecting segment M12 on each of two sides of the data line.

In some embodiments of the present application, the type of the display panel 01 can be an OLED display panel, a liquid crystal display panel, or an LED display panel.

In another aspect, the present application further provides a driving method of the display panel 01. The driving method of the display panel 01 includes: scanning a capacitive touch part CO in the display panel 01 using a touch driving chip, each scan cycle including an electromagnetic scan interval and a capacitive scan interval, wherein during each electromagnetic scan interval, the capacitive touch part C0 performs an electromagnetic touch function, and during each capacitive scan interval, the capacitive touch part C0 performs a capacitive touch function.

In the present application, by dividing each scan cycle into an independent electromagnetic scanning interval and a capacitive scanning interval, the capacitive touch part C0 in the electromagnetic scan interval can be used as an electromagnetic touch channel through a manner of time-division driving. The capacitive touch part C0 can be used as a capacitive touch channel in the capacitive scan interval.

In a third aspect, the first embodiment of the present application further provides a display device. The display device includes a casing and the display panel 01 described above, wherein the casing has an accommodating space, and the display panel 01 is disposed in the accommodating space.

### Second Embodiment

FIG. 10 is a schematic structural view of a touch layer according to a second embodiment of the present application. As shown in FIG. 1 and FIG. 3 to FIG. 10, the second embodiment of the present application provides a display panel 01, a driving method, and a display device. The display panel 01 includes a capacitive touch part C0, and the capacitive touch part C0 includes a first capacitive touch portion C1 and the second capacitive touch portion C2 arranged in different layers. The display panel 01 includes a plurality of electromagnetic coils M0, and the plurality of electromagnetic coils M0 include an electromagnetic touch part E0. The electromagnetic touch part EO includes a first electromagnetic touch portion El and a second electromagnetic touch portion E2 arranged in different layers, wherein the plurality of electromagnetic coils M0 also include the capacitive touch part C0, and the electromagnetic coils lines E11 are arranged in a same layer as the bridging electrodes C21.

In the display panel 01 of the present embodiment, since the electromagnetic coil line E11 and the bridging electrode C21 are arranged in the same layer, the present application prevents a problem of an increased number of film layers and an increased thickness of the display panel 01 due to the inclusion of the electromagnetic coil line E11, which in turn simplifies a manufacturing process of the display panel 01 and reduces production costs.

It should be noted that the structure and the driving method of the display panel 01 and the display device in the second embodiment of the present application are similar to the structure and the driving method of the display panel 01 and the display device in the first embodiment of the present application. A description of the structure and effects of the same elements is not repeated in the second embodiment of the present application.

The difference is that the electromagnetic bridging line E21, the touch electrode C11, and the bridging electrode C21 are arranged in different layers. That is to say, the electromagnetic bridging line E21 is disposed in a film layer where the touch electrode C11 and the bridging electrode C21 are excluded from.

Specifically, the display panel 01 includes a substrate 10 and includes a driving circuit layer 20, a display functional layer 30, an encapsulation layer 40, and a touch layer 50 stacked sequentially on the substrate 10. The electromagnetic touch part EOE is disposed in the touch layer 50. The touch layer 50 includes a third insulating layer 55, a third touch layer 56, a first insulating layer 51, a first touch layer 52, a second insulating layer 53, and a second touch layer 54 stacked sequentially in a direction away from the encapsulation layer 40, wherein the plurality of bridging electrodes C21 and the plurality of electromagnetic coil lines E11 are arranged in the first touch layer 52, the plurality of touch electrodes C11 are arranged in the second touch layer 54, and the electromagnetic bridging line E21 is disposed in the third touch layer 56.

The plurality of touch electrodes C11 has a larger layout area and are more densely arranged. Therefore, when the plurality of touch electrodes C11 and the electromagnetic bridging lines E21 are arranged in the same layer, it will increase the difficulty of wiring. By arranging the electromagnetic bridging lines E21 in the third touch layer 56, the present application can effectively reduce the difficulty of wiring and improve production yields of the display panel 01.

### Third Embodiment

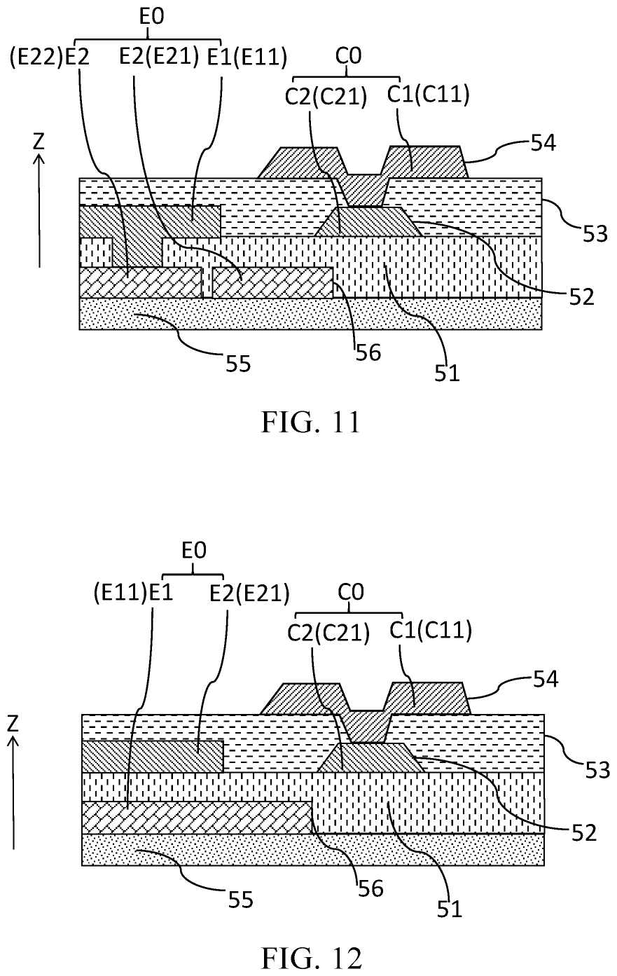

FIG. 11 is a schematic structural view of the touch layer according to a third embodiment of the present application. As shown in FIG. 1, FIG. 3 to FIG. 9, and FIG. 11, the present embodiment provides a display panel 01, a driving method, and a display device. The display panel 01 includes a capacitive touch part C0, and the capacitive touch part C0 includes a first capacitive touch portion C1 and a second capacitive touch portion C2 arranged in different layers. The display panel 01 includes a plurality of electromagnetic coils M0, and the plurality of electromagnetic coils M0 includes an electromagnetic touch part E0. The electromagnetic touch part E0 includes a first electromagnetic touch portion E1 and a second electromagnetic touch portion E2 arranged in different layers, wherein the plurality of electromagnetic coils M0 also include the capacitive touch part C0, the electromagnetic coil line E11 is arranged in a same layer as the bridging electrode C21, and the electromagnetic bridging line E21, the touch electrode C11, and the bridging electrode C21 are arranged in different layers.

In the display panel 01 of the present embodiment, the electromagnetic coil line E11 and the bridging electrode C21 are arranged in the same layer, so the present application can prevent the problem of an increased number of film layers and a greater thickness of display panel 01 due to the inclusion of the electromagnetic coil line E11, which in turn simplifies a manufacturing process of the display panel 01 and reduces production costs. Since the electromagnetic bridging line E21, the touch electrode C11, and the bridging electrode C21 are arranged in different layers, the wiring difficulty can be effectively reduced and production yields of the display panel 01 can be improved.

It should be noted that the structure and driving method of the display panel 01 and the display device in the third embodiment of the present application are similar to the structure and driving method of the display panel 01 and the display device in the second embodiment of the present application. A description of the structure and effects of the same elements are not repeated in the third embodiment of the present application.

The difference is that the second electromagnetic touch portion E2 further includes a plurality of parallelly connected electromagnetic coil structures E22, and the parallelly connected electromagnetic coil structures E22 are connected in parallel with the electromagnetic coil lines E11.

In the display panel 01 of the present embodiment, the second electromagnetic touch portion E2 further includes a plurality of parallelly connected electromagnetic coil structures E22, and the parallelly connected electromagnetic coil structures E22 and the electromagnetic bridging lines E21 are arranged in a same layer. Therefore, the inclusion of the parallelly connected electromagnetic coil structures E22 does not increase the number of film layers of the display panel 01. Moreover, because the parallelly connected electromagnetic coil structures E22 are connected in parallel with the electromagnetic coil lines E11, the present application can reduce resistance of the electromagnetic coil line E11, reduce impedance of an electromagnetic signal when it is transmitted in the electromagnetic touch part E0, and improve accuracy of the electromagnetic signal.

### Fourth Embodiment

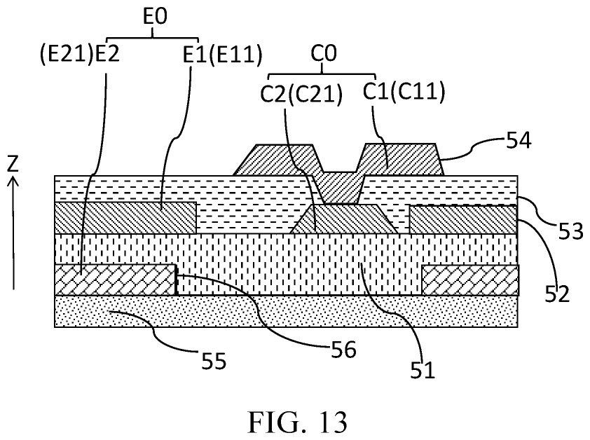

FIG. 12 is a schematic structural view of the touch layer being a first type structure according to the fourth embodiment of the present application, and FIG. 13 is a schematic structural view of the touch layer being a second type structure according to the fourth embodiment of the present application. Referring to FIG. 1, FIG. 12, and FIG. 13, the fourth embodiment of the present application provides a display panel 01 and a display device. The display panel 01 includes a capacitive touch part C0, and the capacitive touch part C0 includes a first capacitive touch portion C1 and a second capacitive touch portion C2 arranged in different layers. The display panel 01 includes a plurality of electromagnetic coils M0, and the plurality of electromagnetic coils M0 include an electromagnetic touch part E0. The electromagnetic touch part E0 includes a first electromagnetic touch portion E1 and a second electromagnetic touch portion E2 arranged in different layers, wherein the first electromagnetic touch portion E1 and the second electromagnetic touch portion E2 are arranged in different layers. At least one of the first electromagnetic touch portions E1 or the second electromagnetic touch portions E2 is arranged in a same layer as the capacitive touch part C0.

It should be noted that the structures of the display panel 01 and the display device in the fourth embodiment of the present application are similar to the structures of the display panel 01 and the display device in the first embodiment of the present application. A description of the structure and effects of the same elements is not repeated in the fourth embodiment of the present application.

The difference is that the plurality of electromagnetic coils M0 do not include the capacitive touch part C0.

In the display panel 01 provided in the embodiment of the present application, since the plurality of electromagnetic coils M0 do not include the capacitive touch part C0, the capacitive touch part C0 is arranged independently from the electromagnetic touch part E0, the electromagnetic touch part E0 only has a touch function, and does not participate in the formation of the electromagnetic coil M0, so that the capacitive touch and electromagnetic touch functions of the display panel 01 do not affect each other.

Referring to FIG. 12, when the electromagnetic bridging line E21 is arranged on the same layer as the bridging electrode C21, the electromagnetic coil line E11 is arranged on different layers from the touch electrode C11 and the bridging electrode C21. Referring to FIG. 13, when the electromagnetic coil line E11 is arranged on the same layer as the bridging electrode C21, the electromagnetic bridging line E21 is arranged on different layers from the touch electrode C11 and the bridging electrode C21.

In summary, the present application provides a display panel and a driving method. The display panel includes the capacitive touch part, and the capacitive touch part includes a first capacitive touch portion and a second capacitive touch portion arranged in different layers. The display panel includes a plurality of electromagnetic coils, and the plurality of electromagnetic coils include an electromagnetic touch part. The electromagnetic touch part includes a first electromagnetic touch portion and a second electromagnetic touch portion arranged in different layers. At least one of the first electromagnetic touch portion and the second electromagnetic touch portion is disposed in a same layer as the capacitive touch part. By arranging at least one of the first electromagnetic touch portion and the second electromagnetic touch portion to be disposed in a same layer as the capacitive touch part, a space of a film layer where the capacitive touch part is located can be used to form a partial structure of the electromagnetic touch part, which in turns reduces an overall thickness of the display panel equipped with electromagnetic touch functionality and decreases the complexity of a manufacturing process.

The above is a detailed description about a display panel and a driving method according to the present application. In the present disclosure, specific examples are used to illustrate the principles and implementation of the present application. The description of the above embodiment is only for ease of understanding the present application and its main ideas. Those skilled in the art, based on the ideas of the present application, can change the embodiments and protection scope of the present application. In summary, the content of the present specification should not be construed as limiting the application.

1. A display panel, comprising:
a capacitive touch part comprising a first capacitive touch portion and a second capacitive touch portion arranged in different layers;
a plurality of electromagnetic coils, comprise an electromagnetic touch part that comprises a first electromagnetic touch portion and a second electromagnetic touch portion arranged in different layers, wherein at least one of the first electromagnetic touch portion and the second electromagnetic touch portion is arranged in a same layer as the capacitive touch part.

2. The display panel according to claim 1, wherein the plurality of electromagnetic coils further comprise the capacitive touch part.

3. The display panel according to claim 2, wherein the first capacitive touch portion comprises a plurality of touch electrodes, the second capacitive touch portion comprises a plurality of bridging electrodes, the first electromagnetic touch portion comprises a plurality of electromagnetic coil lines, and the second electromagnetic touch portion comprises a plurality of electromagnetic bridging lines;
wherein an area of the plurality of touch electrodes is larger than an area of the plurality of bridging electrodes, an area of the plurality of electromagnetic coil lines is larger than an area of the plurality of electromagnetic bridging lines, and the electromagnetic coil lines are arranged in a same layer as the bridging electrodes.

4. The display panel according to claim 3, wherein the electromagnetic bridging lines are arranged in a same layer as the touch electrodes.

5. The display panel according to claim 4, further comprising a substrate, a driving circuit layer, a display functional layer, an encapsulation layer, and a touch layer sequentially stacked on the substrate, wherein the touch layer comprises a first insulating layer, a first touch layer, a second insulating layer, and a second touch layer sequentially stacked in a direction away from the encapsulation layer, wherein the electromagnetic coil lines and the bridging electrodes are disposed in the first touch layer, and the electromagnetic bridging lines and the touch electrodes are disposed in the second touch layer.

6. The display panel according to claim 5, wherein the electromagnetic bridging lines and the touch electrodes are staggered with respect to each other in the second touch layer, and the electromagnetic coil lines and the bridging electrodes are staggered with respect to each other in the first touch layer.

7. The display panel according to claim 3, wherein each of the electromagnetic bridging lines, each of the touch electrodes, and each of the bridging electrodes are arranged in different layers.

8. The display panel according to claim 7, further comprising a substrate, a driving circuit layer, a display functional layer, an encapsulation layer, and a touch layer sequentially stacked on the substrate, wherein the touch layer comprises a third insulating layer, a third touch layer, a first insulating layer, a first touch layer, a second insulating layer, and a second touch layer sequentially stacked in a direction away from the encapsulation layer, wherein the electromagnetic coil lines and the bridging electrodes are disposed in the first touch layer, the touch electrodes are disposed in the second touch layer, and the electromagnetic bridging lines are disposed in the third touch layer.

9. The display panel according to claim 7, wherein the second electromagnetic touch portion further comprises a plurality of parallelly connected electromagnetic coil structures, and the parallelly connected electromagnetic coil structures are connected in parallel with the electromagnetic coil lines.

10. The display panel according to claim 9, further comprising a substrate, a driving circuit layer, a display functional layer, an encapsulation layer, and a touch layer sequentially stacked on the substrate, wherein the touch layer comprises a third insulating layer, a third touch layer, a first insulating layer, a first touch layer, a second insulating layer, and a second touch layer sequentially stacked in a direction away from the encapsulation layer, wherein the electromagnetic coil lines and the bridging electrodes are disposed in the first touch layer, the touch electrodes are disposed in the second touch layer, and the electromagnetic bridging lines and the parallelly connected electromagnetic coil structures are disposed in the third touch layer.

11. The display panel according to claim 3, wherein the touch electrodes comprise a plurality of first touch electrodes and a plurality of second touch electrodes, each of the first touch electrode comprises a plurality of first touch sub-electrodes arranged sequentially in a first direction, each two adjacent first touch sub-electrodes are electrically connected to each other, the second touch electrodes comprise a plurality of second touch sub-electrodes arranged sequentially in a second direction, and each two adjacent second touch sub-electrodes are electrically connected by the corresponding bridging electrode;
the electromagnetic coils comprise a plurality of first electromagnetic coils and a plurality of second electromagnetic coils;
each of the first electromagnetic coils comprises two first main segments extending along the first direction, wherein one of the two first main segments comprises the corresponding electromagnetic coil line, and the other one of the two first main segments comprises the corresponding first touch electrode;
each of the second electromagnetic coils comprises two second main segments extending along the second direction, wherein one of the two second main segments comprises the corresponding electromagnetic coil line, and the other one of the two second main segments comprises the corresponding second touch electrode; and
the first direction is perpendicular to the second direction.

12. The display panel according to claim 11, wherein an orthographic projection of the electromagnetic bridging line in a third direction is non-overlapped with an orthographic projection of the bridging electrode in the third direction, and the third direction is perpendicular to the first direction and the second direction.

13. The display panel according to claim 11, wherein an area surrounded by each of the first electromagnetic coils partially overlaps with an area surrounded by at least one of the first electromagnetic coils, and an area surrounded by each of the second electromagnetic coils partially overlaps with an area surrounded by at least one of the second electromagnetic coils.

14. The display panel according to claim 11, wherein each of the first electromagnetic coils further comprises a first connecting segment connected to the two first main segments, and each of the second electromagnetic coils further comprises a second connecting segment connected to the two second main segments;
the display panel comprises a plurality of data lines parallel to the first main segments or the second main segments;
when the first main segments are parallel to the data lines, at least one of the second connecting segments is disposed on each of two sides of the respective data lines; and
when the second main segments are parallel to the data lines, at least one of the first connecting segments is disposed on each of two sides of the respective data lines.

15. The display panel according to claim 2, wherein the display panel is an organic light-emitting diode (OLED) display panel, a liquid crystal display panel, or a light-emitting diode (LED) display panel.

16. A driving method of a display panel for driving the display panel of any one of claims 2 to 151, wherein the driving method of the display panel comprises:
scanning a capacitive touch part in the display panel using a touch driving chip, each scan cycle comprising an electromagnetic scan interval and a capacitive scan interval, wherein during each of the electromagnetic scan intervals, the capacitive touch part performs an electromagnetic touch function, and during each of the capacitive scan intervals, the capacitive touch part performs a capacitive touch function.

17. The driving method of the display panel according to claim 16, wherein the plurality of electromagnetic coils are exclusive of the capacitive touch part.

18. The driving method of the display panel according to claim 17, wherein the first capacitive touch portion comprises a plurality of touch electrodes, the second capacitive touch portion comprises a plurality of bridging electrodes, the first electromagnetic touch portion comprises a plurality of electromagnetic coil lines, and the second electromagnetic touch portion comprises a plurality of electromagnetic bridging lines;
wherein an area of the plurality of touch electrodes is larger than an area of the plurality of bridging electrodes, and an area of the plurality of electromagnetic coil lines is larger than an area of the plurality of electromagnetic bridging lines.

19. The driving method of the display panel according to claim 18, wherein the electromagnetic bridging lines are arranged in a same layer as the bridging electrodes, and each of the electromagnetic coil lines, each of the touch electrodes, and each of the bridging electrodes are arranged in different layers.

20. The driving method of the display panel according to claim 18, wherein the electromagnetic coil lines are arranged in a same layer as the bridging electrodes, and each of the electromagnetic bridging lines, each of the touch electrodes, and each of the bridging electrodes are arranged in different layers.
